(19) United States
(12) Patent Application Publication
(10) Pub. No.: US 2010/0251105 A1
(43) Pub. Date: Sep. 30, 2010

(54) METHOD, APPARATUS, AND SYSTEM FOR MODIFYING SUBSTITUTION COSTS

(75) Inventors: Justin Tyler Dubs, Durham, NC (US); Harriss Christopher Neil Ganey, Cary, NC (US); Aaron Michael Stewart, Raleigh, NC (US); Jennifer Greenwood Zawacki, Hillsborough, NC (US)

Correspondence Address: Kunzler Needham Massey & Thorpe, 8 EAST BROADWAY, SUITE 600, SALT LAKE CITY, UT, 84111, US

(73) Assignee: LENOVO (SINGAPORE) PTE, LTD., New Tech Park (SG)

(21) Appl. No.: 12/415,695

(22) Filed: Mar. 31, 2009

(51) Int. Cl. G06F 17/21; G06F 3/02; G06F 3/041

(52) U.S. Cl. 715/257; 345/168; 345/173

(57) ABSTRACT

A method, apparatus, and system are disclosed for modifying substitution cost. A substitution cost module calculates a substitution cost between a first character of a first string and a second character of a second string. A spatial vector module calculates a spatial vector between the first character and the second character from a location of a first key representing the first character on a keyboard and a location of a second key representing the second character on the keyboard. The spatial vector module modifies the substitution cost if the spatial vector is less than a spatial threshold. An edit distance module calculates an edit distance between the first string and the second string using the modified substitution cost for the substitution cost of substituting the first character with the second character.

### BACKGROUND

1. Field

This invention relates to substitution costs and more particularly to modifying substitution costs.

2. Description of the Related Art

Spell check programs are often used to determine if a user has correctly typed a word, or if the user has mis-keyed or misspelled the word. For example, a spell check program may determine that the user mis-keyed “the” as “hte.”

Spell check programs are often based on an edit distance between strings of characters. A spell check program may calculate edit distances between a typed string and a plurality of potential replacements strings. The spell check program may suggest the potential replacements strings with small edit distances or replace the typed string with a likely replacement string.

Unfortunately, spell check programs do not consider keyboard layout and the errors that may result from keyboard layout. As a result, common typing mistakes have a reduced probability of being correctly identified.

### SUMMARY

From the foregoing discussion, there is a need for a method, apparatus, and system that modifies substitution cost based on keyboard layout when calculating edit distances. Beneficially, such a method, apparatus, and system would reduce the calculated substitution cost of mis-keyed characters so that a correct potential replacement string for a mis-keyed character string is more likely to be identified.

The present invention has been developed in response to the present state of the art, and in particular, in response to the problems and needs in the art that have not yet been fully solved by currently available edit distance calculation methods. Accordingly, the present invention has been developed to provide a method, apparatus, and system for modifying substitution cost that overcome many or all of the above-discussed shortcomings in the art.

A method of the present invention is presented for modifying substitution cost. In one embodiment, the method includes calculating the substitution cost, calculating a spatial vector, modifying a substitution costs, and calculating an edit distance.

A substitution cost module calculates a substitution cost between a first character of a first string and a second character of a second string. A spatial vector module calculates a spatial vector between the first character and the second character from a location of a first key representing the first character on a keyboard and a location of a second key representing the second character on the keyboard. The spatial vector module modifies the substitution cost if the spatial vector is less than a spatial threshold. An edit distance module calculates an edit distance between the first string and the second string using the modified substitution cost for the substitution cost of substituting the first character with the second character.

The apparatus is provided with a plurality of modules configured to functionally execute the steps of the method. The modules include a substitution cost module, a spatial vector module, and an edit distance module. The modules may also include a touch location module and a user adjustment module.

The substitution cost module calculates a substitution cost between a first character of a first string and a second character of a second string. The spatial vector module calculates a spatial vector between the first character and the second character from a location of a first key representing the first character on a keyboard and a location of a second key representing the second character on the keyboard. The spatial vector module modifies the substitution cost if the spatial vector is less than a spatial threshold. The edit distance module calculates an edit distance between the first string and the second string using the modified substitution cost for the substitution cost of substituting the first character with the second character.

A system of the present invention is also presented. The system may be embodied in a computer. In particular, the system, in one embodiment, includes a touch screen, a computer readable storage medium, and a processor.

The touch screen displays a keyboard. The computer readable storage medium stores a computer readable program. The processor executes the computer readable program. The computer readable program comprises a substitution cost module, a spatial vector module, and edit distance module.

The substitution cost module calculates a substitution cost between a first character of a first string and a second character of a second string. The spatial vector module calculates a spatial vector between the first character and the second character from a location of a first key representing the first character on the keyboard and a location of a second key representing the second character on the keyboard. The spatial vector module modifies the substitution cost if the spatial vector is less than a spatial threshold. The edit distance module calculates an edit distance between the first string and the second string using the modified substitution cost for the substitution cost of substituting the first character with the second character. The edit distance module further modifies the first string to the second string in response to the edit distance.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention modifies a substitution cost for substituting a first character with a second character in an edit distance calculation using relative locations of a first key representing the first character and the second key representing the second character. Thus mis-keying events may be given greater significance by a spell check program. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing illustrating one embodiment of a touch screen computer in accordance with the present invention;

FIG. 2 is a perspective drawing illustrating one embodiment of a projected virtual keyboard of the present invention;

FIG. 3 is a top view drawing illustrating one embodiment of keyboard keys of the present invention;

FIG. 4 is a top view drawing illustrating one embodiment of keyboard keys with a spatial vector of the present invention;

FIG. 5 is a top view drawing illustrating one alternate embodiment of keyboard keys with a spatial vector of the present invention;

FIG. 6 is a schematic block diagram illustrating one embodiment of a computer of the present invention;

FIG. 7 is a schematic block diagram illustrating one embodiment of a substitution cost apparatus of the present invention;

FIG. 8 is a schematic flow chart diagram illustrating one embodiment of a substitution cost modification method of the present invention;

FIG. 9 is a schematic flow chart diagram illustrating one embodiment of a user adjustment vector calculation method of the present invention; and

FIG. 10 is a schematic block diagram illustrating one embodiment of a user touch location area and keyboard keys of the present invention.

### DETAILED DESCRIPTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform logic functions, execute computer readable programs stored on tangible storage devices, and/or execute programmed functions. Modules may also include a computer readable storage medium comprising a computer readable program stored on a tangible storage device that performs a function when executed by a hardware circuits such as a processor, microcontroller, or the like.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

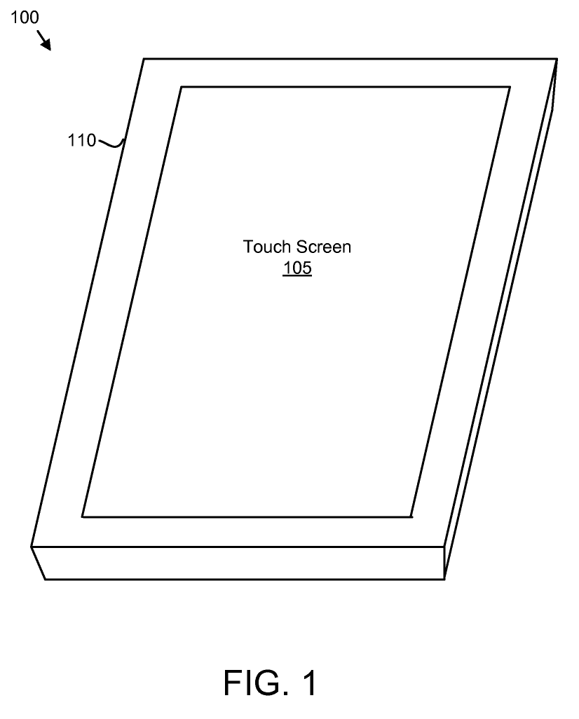

FIG. 1 is a perspective drawing illustrating one embodiment of a touch screen computer 100 in accordance with the present invention. The computer 100 includes a case 110 with a touch screen 105. The touch screen 105 may display images including text and data to a user. The touch screen 105 may also display a virtual keyboard. The user may input data to the computer 100 using the virtual keyboard. Hereafter a virtual keyboard is referred to as a keyboard.

In an alternate embodiment, the computer 100 may be embodied in a tabletop. The touch screen 105 may display the keyboard on the tabletop. The touch screen 105 may also be embedded in a dashboard, an appliance, or the like.

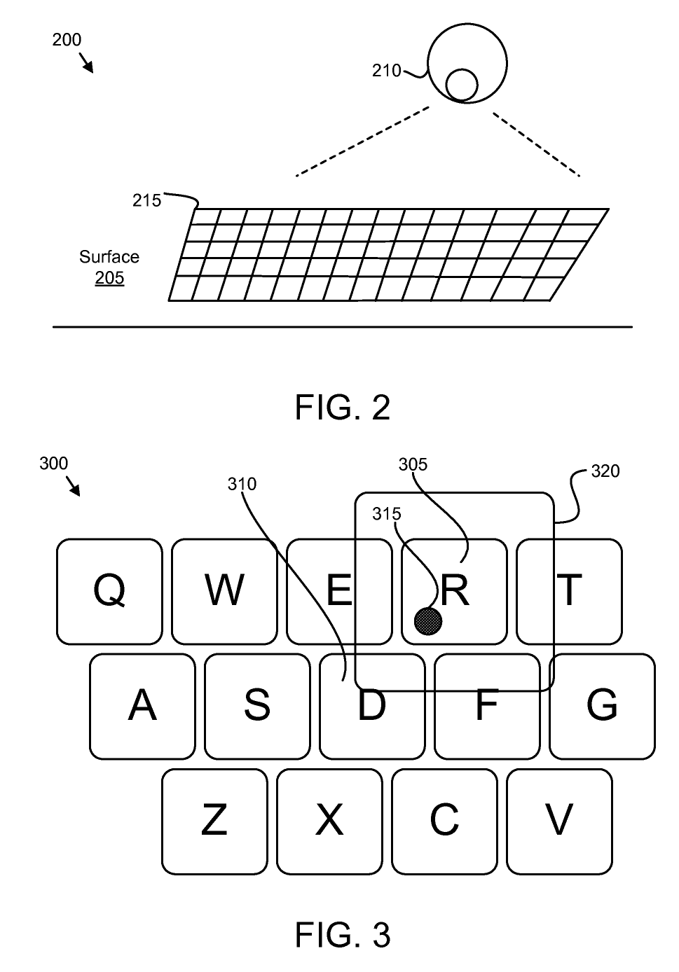

FIG. 2 is a perspective drawing illustrating one embodiment of a projected virtual keyboard 200 of the present invention. A projector 210 projects a keyboard 215 on a surface 205. The surface 205 may be a tabletop, a retractable tray, or the like. The keyboard 215 may be represented as key outlines. Alternatively, the keyboard 215 may be represented as key characters. In one embodiment, the keyboard 215 is represented as a combination of key outlines and key characters. A computer may communicate images to the projector 210 for display, including the keyboard images.

FIG. 3 is a top view drawing illustrating one embodiment of keyboard keys 300 of the present invention. The keys 300 may be displayed by the touch screen 105 of FIG. 1 and/or the projected virtual keyboard 215 of FIG. 2. For simplicity, only a portion of the keys 300 of the keyboard are displayed. One of skill in the art will recognize that the invention may be practiced with any combination of keys on any keyboard.

The keys 300 are depicted with a first key 305 and a second key 310. The first key 305 and second key 310 are exemplary of any keys 300 on the keyboard. The first key 305 is a key keyed by a user in typing a first character of a first string. The second key 310 is a key the user intended to key to enter an intended second character as part of an intended second string. However, instead of keying the second key 310 the user keyed the first key 305 at a touch location 315. For example, the user may have intended to key the second string “code” but instead keyed the first string “core.”

A spell check program or data entry check program may calculate an edit distance between the first string and the second string. For example, The data entry check program may calculate a Wagner-Fischer matrix to determine an edit distance between the first and second string. The Wagner-Fischer matrix may include a calculated substitution cost for replacing the first character with the second character. In the past, substitution costs have not accounted for relative positions of the first key 305 and the second key 310. The present invention modifies substitution costs to account for the positions of keys when calculating edit distance as will be described hereafter.

A spatial threshold 320 is shown surrounding the first key 305. In the depicted embodiment, the spatial threshold 320 is a specified distance from an edge of the first key 305. In an alternate embodiment, the spatial threshold 320 is a specified distance from an edge of the second key 310. The present invention employs the spatial threshold 320 to determine whether to modify a substitution cost for a substitution from the first character to the second character as will be described hereafter.

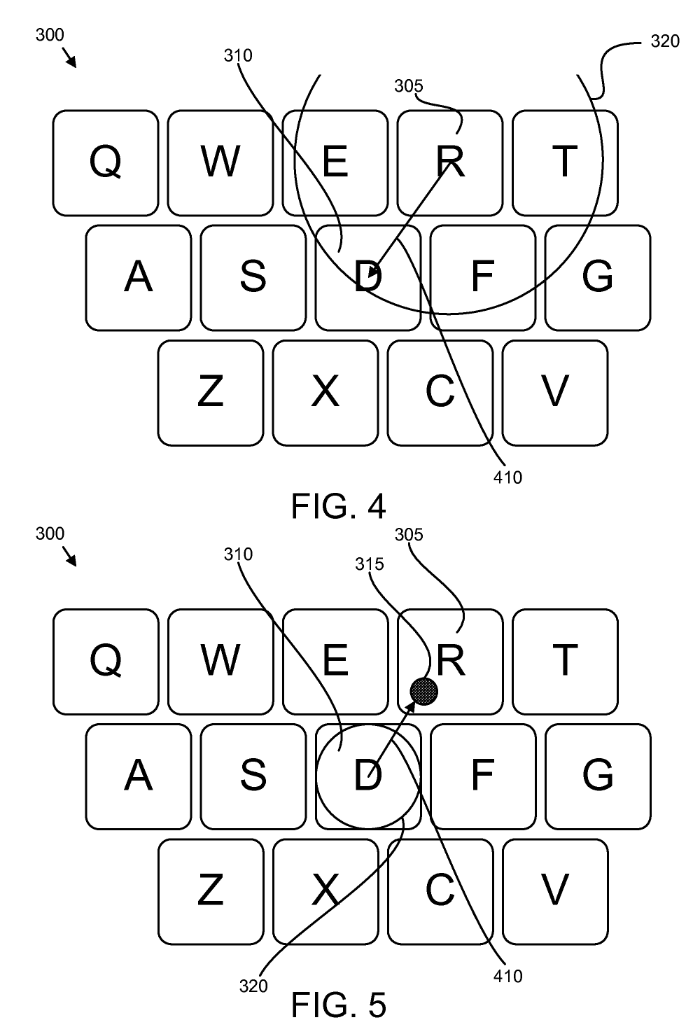

FIG. 4 is a top view drawing illustrating one embodiment of keyboard keys 300 with a spatial vector 410 of the present invention. The keys 300 of FIG. 3 are shown. The description of FIG. 4 refers to elements of FIGS. 1-3, like numbers referring to like elements.

A spatial vector 410 is shown between the first key 305 and the second key 310. In one embodiment, the spatial vector 410 includes a scalar length and a directional vector. Alternatively, the spatial vector 410 may only include a scalar length. In one embodiment, a plurality of spatial factors 410 is calculated between the first key 305 and a plurality of second keys 310. The present invention employs the spatial vector 410 with the spatial threshold 320 to determine whether to modify a substitution cost as will be described hereafter.

The spatial threshold 320 is also shown. In the depicted embodiment, the spatial threshold 320 is a radius from a center of the first key 305. Alternatively, the spatial threshold 320 may be a radius from a center of the second key 310.

FIG. 5 is a top view drawing illustrating one alternate embodiment of keyboard keys 300 with a spatial vector 410 of the present invention. The keys 300 of FIGS. 3 and 4 are shown. The description of FIG. 5 refers to elements of FIGS. 1-4, like numbers referring to like elements.

In embodiment, the spatial vector 410 extends from the second key 310 to the touch location 315. In addition, the spatial threshold 320 is depicted as a radius from the center of the second key 310. The spatial threshold 320 is depicted completely within the second key 310.

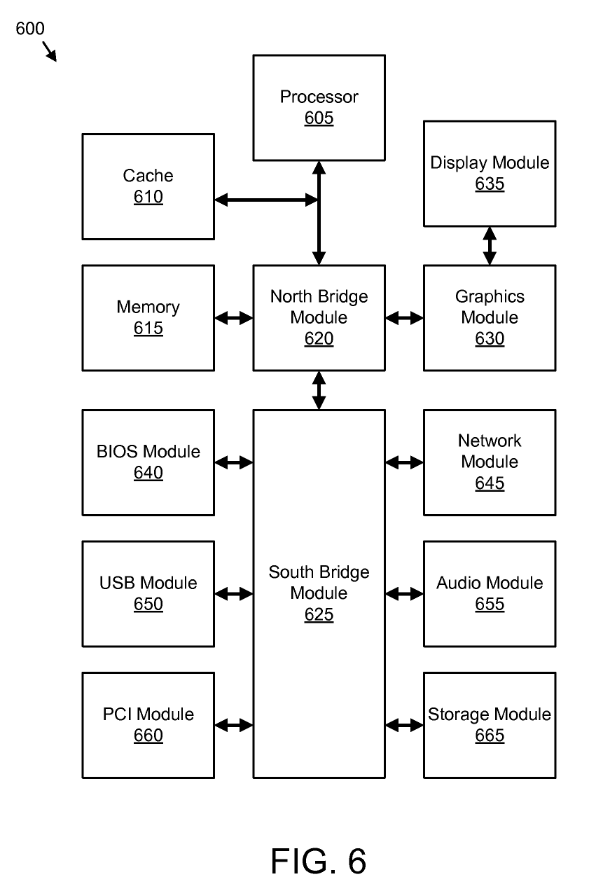

FIG. 6 is a schematic block diagram illustrating one embodiment of a computer 600 of the present invention. The description of the computer 600 refers to elements of FIGS. 1-5, like numbers referring to like elements. The computer 600 includes a processor 605, a cache 610, a memory 615, a north bridge module 620, a south bridge module 625, a graphics module 630, a display module 635, a basic input/output system (BIOS) module 640, a network module 645, a universal serial bus (USB) module 650, an audio module 655, a peripheral component interconnect (PCI) module 660, and a storage module 665.

The processor 605, cache 610, memory 615, north bridge module 620, south bridge module 625, graphics module 630, display module 635, BIOS module 640, network module 645, USB module 650, audio module 655, PCI module 660, and storage module 665, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory 615 tangibly stores computer readable programs. The processor 605 executes the computer readable programs as is well known to those skilled in the art. The computer readable programs may also be tangibly stored in the storage module 665. The storage module 665 may be a hard disk drive, an optical storage device, a holographic storage device, a micromechanical storage device, a semiconductor storage device, or the like.

The processor 605 may communicate with the cache 610 through a processor interface bus to reduce the average time to access memory 615. The cache 610 may store copies of the data from the most frequently used memory 615 locations. The computer 600 may use one or more caches 610 such as a Double Data Rate 2 (DDR2) cache memory or the like.

The north bridge module 620 may communicate with and provide bridging functionality between the processor 605, the graphic module 630, the memory 615, and the cache 610. The processor 605 may be connected to the north bridge module 620 over a, for example, six hundred sixty seven Megahertz (667 MHz) front side bus.

The north bridge module 620 may be connected to the south bridge module 625 through a direct media interface (DMI) bus. The DMI bus may provide a high-speed, bi-directional, point-to-point link supporting a clock rate for example of one Gigabytes per second (1 GBps) in each direction between the north bridge module 620 and the south bridge module 625. The south bridge module 625 may support and communicate with the BIOS module 640, the network module 645, the PCI module 660, and the storage module 665.

The PCI module 660 may communicate with the south bridge module 625 for transferring data or power to peripheral devices. In one embodiment, the PCI module 660 receives virtual key inputs from the keys 300 of FIGS. 3-5. The touch screen 105 or keyboard 215 may include the keys.

The BIOS module 640 may communicate instructions through the south bridge module 625 to boot the computer 600, so that computer readable software instructions stored on the storage module 665 can load, execute, and assume control of the computer 600. Alternatively, the BIOS module 640 may comprise a coded program embedded on a chipset that recognizes and controls various devices that make up the computer 600.

The network module 645 may communicate with the south bridge module 625 to allow the computer 600 to communicate with other devices over a network. The devices may include routers, bridges, computers, printers, and the like.

The display module 635 may communicate with the graphic module 630 to display information as will be described hereafter. The display module 635 may be the touch screen 105 of FIG. 1. The USB module 650 may communicate with one or more USB compatible devices over a USB bus. The audio module 655 may generate an audio output.

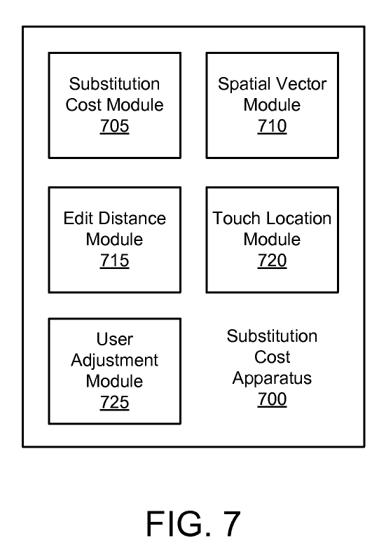

FIG. 7 is a schematic block diagram illustrating one embodiment of a substitution cost apparatus 700 of the present invention. The apparatus 700 may be embodied in a computer 600 of FIG. 6. The description of the apparatus 700 refers to elements of FIGS. 1-5, like numbers referring to like elements. The apparatus 700 includes a substitution cost module 705, a spatial vector module 710, an edit distance module 715, a touch location module 720, and a user adjustment module 725.

In one embodiment, the apparatus 700 comprises a computer readable storage medium such as the memory 615 and/or the storage module 665 of the computer 600. The computer readable storage medium stores computer readable program. The processor 605 executes a computer readable program. The computer readable program may comprise the substitution cost module 705, spatial vector module 710, edit distance module 715, touch location module 720, and user adjustment module 725.

The substitution cost module 705 calculates a substitution cost between the first character of the first string and the second character of the second string. The first character is represented by the first key 305 on a keyboard such as a keyboard displayed on the touch screen 105 or the projected keyboard 215. In addition, the second character is represented by the second key 310 of the keyboard.

The spatial vector module 710 calculates the spatial vector 410 between the first character and the second character from the location of the first key 305 and the location of the second key 310 on the keyboard. The spatial vector module 710 modifies the substitution cost if the spatial vector 410 is less than the spatial threshold 320 as will be described hereafter.

The edit distance module 715 calculates an edit distance between the first string and the second string using the modified substitution cost for the substitution cost of substituting the first character with the second character. In one embodiment, the edit distance module 715 calculates the edit distance using the modified substitution cost and 10 calculates the edit distance a second time without using the modified substitution cost. The edit distance module 715 further modifies the first string to the second string in response to the edit distance.

In one embodiment, the touch location module 720 logs each user touch location 315 on the keyboard for a plurality of modified first strings and calculates a user adjustment vector from the plurality of logged user touch locations 315. The touch location module 720 may store the user touch locations 315 on a computer readable storage medium such as the memory 615. In one embodiment, the touch location module 720 stores a location of a center of the user touch location 315. Alternatively, the touch location module 720 may store the center and a radius of the user touch location 315. In a certain embodiment, the touch location module 720 stores of pixilated description of the user touch location 315.

The touch location module 720 may further calculate a user adjustment vector from the plurality of logged user touch locations. The substitution cost module 705 may modify the spatial vector 410 with the user adjustment vector.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

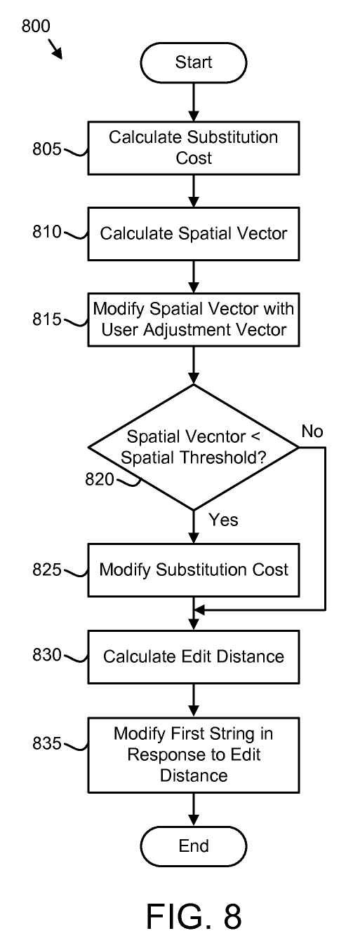

FIG. 8 is a schematic flow chart diagram illustrating one embodiment of a substitution cost modification method 800 of the present invention. The method 800 substantially includes the steps to carry out the functions presented above with respect to the operation of the described apparatus 700 and systems 100, 200, and 600 of FIGS. 1, 2, and 6. In one embodiment, the method 800 is implemented with a computer readable storage medium comprising a computer readable program stored on a tangible storage device. The computer readable storage medium may be integrated into a computing system, such as the computer 600, wherein the computer readable program executed by the computing system performs the method 800.

The method 800 starts, and the substitution cost module 705 calculates 805 a substitution cost between the first character of the first string and the second character of the second string. The first string comprises a plurality of characters including the first character. The plurality of characters is entered on the keyboard by the user. The keyboard may be the touch screen 105 FIG. 1. Alternatively, the keyboard may be a virtual keyboard 215 of FIG. 2. The first character is represented by the first key 305 and the second character is represented by the second key 310 of FIGS. 3-5.

The spatial vector module 710 calculates 810 the spatial vector 410 between the first character and the second character from the location of the first key 305 and the location of the second key 310 on the keyboard. The spatial vector 410 may have a first endpoint at the center of the first key 305 and a second endpoint at the center of the second key 310. Alternatively, the spatial vector 410 may have a first endpoint at the center of the second key 310 and a second endpoint at the center of the touch location 315. In a certain embodiment, the spatial vector 410 may have a first endpoint at the center of the first key 305 and a second endpoint at the center of touch location 315.

The spatial vector 410 may include a scalar length between the first and second endpoints. The scalar length may be measured in millimeters. In addition, the scalar vector 410 may include a directional component such as a direction measured in radians or degrees. In an alternate embodiment, the spatial vector 410 may include scalar lengths along a first and second axis.

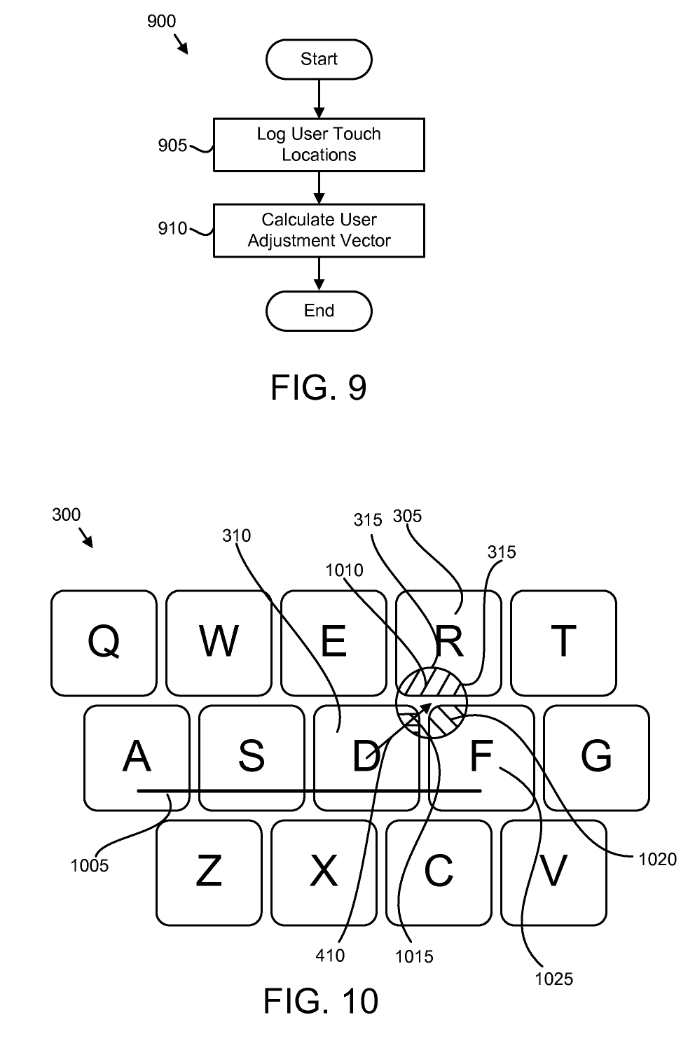

In one embodiment, the substitution cost module 705 modifies 815 the spatial vector 410 with a user adjustment vector. The calculation of the user adjustment vector is described in FIG. 9. For example, the substitution cost module 705 may modify 915 the spatial vector 410 with the user adjustment vector by summing the spatial vector 410 with the user adjustment vector to yield a modified spatial vector 410. Alternatively, the substitution cost module 705 may modify 915 the spatial vector 410 with the user adjustment vector by multiplying the spatial vector 410 by the user adjustment vector.

The spatial vector module 710 determines 820 if the spatial vector 410 is less than the spatial threshold 320. In one embodiment, the spatial vector module 710 determines 820 that the spatial vector 410 is less than the spatial threshold 320 if a specified endpoint of the spatial vector 410 lies within the boundaries of the spatial threshold 320. In an alternate embodiment, the spatial vector module 710 determines 820 at the spatial vector 410 is less than the spatial threshold 320 if the scalar length of the spatial vector 410 is less than a radius of the spatial threshold 320.

If the spatial vector module 710 determines 820 the spatial vector 410 is not less than the spatial threshold 320, the edit distance module 715 calculates 830 an edit distance between the first string and the second string using the original substitution cost of substituting the first character with the second character. In one embodiment, the edit distance module employs a Wagner-Fischer algorithm to calculate the edit distance.

If the spatial vector module 710 determines 820 the spatial vector 410 is less than the spatial threshold 320, the spatial vector module 710 modifies 825 the substitution cost. In one embodiment, the spatial vector module 710 calculates the modified substitution cost c′ using Equation 1, where c is an original substitution cost and k₁ is a constant. In one embodiment, k₁ is in the range of 0.3 to 0.8. In a certain embodiment, k₁ is in the range of 0.5 to 0.67.

c′=k₁*c Equation 1

In an alternate embodiment, the spatial vector module 710 calculates the modified substitution cost c′ using Equation 2, where k₂ is a constant, v is a scalar length of the spatial vector from the first key to the second key and vₘₐₓ is a longest spatial vector from the first key 305 to any other key on the keyboard. Alternatively, vₘₐₓ is a longest spatial vector from the second key 310 to any other key on the keyboard. In one embodiment, k₂ is in the range of 0.2 to 0.9.

c′=c*k₂*(v/vₘₐₓ)² Equation 2

In one embodiment, the spatial vector module 710 calculates the modified substitution cost c′ using Equation 3, where a is an area of the user touch location 315 within an area of the second key 310 divided by a total area of the user touch location 315 and k₃ is a constant. The areas of the user touch location 315 within an area of the second key 310 and the total area of the user touch location 315 are illustrated in FIG. 10.

c′=k₃*(1−a)*c Equation 3

The edit distance module 715 further calculates 830 the edit distance between the first string and the second string using the modified substitution cost for the substitution cost of substituting the first character with the second character. In one embodiment, the edit distance module employs a Wagner-Fischer algorithm with the modified substitution cost to calculate the edit distance. The edit distance module 715 may modify 835 the first string to the second string in response to the edit distance and the method 800 ends.

The present invention modifies the substitution cost used in the edit distance calculation to account the relative positions of the keys 300 representing first and second characters in the first and second string. As a result, a mis-keyed character resulting from a user unintentionally touching an area removed from a desired key is given a lower substitution cost value and so more consideration as a possible replacement in the edit distance calculation.

FIG. 9 is a schematic flow chart diagram illustrating one embodiment of a user adjustment vector calculation method 900 of the present invention. The method 900 substantially includes the steps to carry out the functions presented above with respect to the operation of the described apparatus 700 and systems 100, 200, and 600 of FIGS. 1, 2, and 6. In one embodiment, the method 900 is implemented with a computer readable storage medium comprising a computer readable program stored on a tangible storage device. The computer readable storage medium may be integrated into a computing system, such as the computer 600, wherein the computer readable program executed by the computing system performs the method 900.

The method 900 starts, an in one embodiment, the touch location module 720 logs 905 each user touch location 315 on the keyboard for a plurality of modified first strings. For example, each time the substitution cost module 705 modifies 825 a substitution cost for the second character and the edit distance module 715 modifies 835 the first string with the second character, the touch location module 720 may log 905 the user touch location 315 for the first key 305. In an alternate embodiment, the touch location module 720 logs 905 each user touch location 315 for each keystroke made by the user. The touch location module 720 may store the user touch locations 315 on the computer readable storage medium.

The touch location module 720 may further calculate 910 the user adjustment vector from the plurality of logged user touch locations 315. In one embodiment, the touch location module 720 calculates 910 a user adjustment vector for each key 300 of the keyboard. For example, the touch location module 720 may calculate 910 a first user adjustment vector for the first key 305 and a second user adjustment vector for the second key 310.

In an alternate embodiment, the user adjustment vector is calculated from a home position centerline. In one embodiment, the home position centerline describes a base position of the user's fingers on the keyboard. The touch location module 720 may calculate 910 a plurality of user adjustment vectors radiating from the home position centerline.

In one embodiment, the user adjustment vector is a sum of vectors from the second key 310 to the touch location 315. Alternatively, the user adjustment vector is a sum of vectors from the touch location 315 to the second key 310. In a certain embodiment, the user adjustment vector is a sum of the difference of vectors from the home position centerline to the first key 305 and from the home position centerline to the second key 310.

In one embodiment, the user adjustment vector vₐ is calculated using Equation 4, where v₁ is a scalar distance from the home position centerline to the first key 305 and v₂ is a scalar distance from the home position centerline to the second key 310.

vₐ=Σv₂/v₁ Equation 4

FIG. 10 is a schematic block diagram illustrating one embodiment of a touch location 315 and keyboard keys 300 of the present invention. The keys 300 and touch location 315 are the keys and touch location 315 of FIG. 3. The description of FIG. 10 refers to elements of FIGS. 1-9, like numbers referring to like elements.

The touch location 315 is shown with portions in three keys. A first portion 1010 is an area within the “R” first key 305. A second portion 1015 is an area within the “D” second key 310. A third portion 1020 is an area within an “F” third key 1025.

The spatial vector module 710 may calculate 820 the modified substitution cost c′ for the second key 310 “D” using Equation 3, where a is the area of the second portion 1015 divided by the area of the touch location 315.

The present invention modifies a substitution cost for substituting first character with a second character using relative locations of a first key representing the first character in the second key representing the second character. Thus mis-keying events may be given greater significance by in an edit distance calculation by reducing the substitution cost. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer readable storage medium comprising a computer readable program stored on a tangible storage device for modifying substitution cost, wherein the computer readable program when executed on a computer causes the computer to:
calculate a substitution cost between a first character of a first string and a second character of a second string;
calculate a spatial vector between the first character and the second character from a location of a first key representing the first character on a keyboard and a location of a second key representing the second character on the keyboard;
modify the substitution cost if the spatial vector is less than a spatial threshold; and
calculate an edit distance between the first string and the second string using the modified substitution cost for the substitution cost of substituting the first character with the second character.

2. The computer readable storage medium of claim 1, wherein the modification of the substation cost c is calculated as k₁*c where k₁ is a constant.

3. The computer readable storage medium of claim 1, wherein the modification of the substation cost c is calculated as c*k₂*(v/vₘₐₓ)² where k₂ is a constant, v is a length of the spatial vector from the first key to the second key and vₘₐₓ is a longest spatial vector from the first key to any other key on the keyboard.

4. The computer readable storage medium of claim 1, wherein modification of the substation cost c is calculated as k₃*(1−a)*c where a is an area of a user touch location within an area of the second key divided by a total area of the user touch location and k₃ is a constant.

5. The computer readable storage medium of claim 1, wherein the computer readable program further causes the computer to:
modify the first string to the second string in response to the edit distance;
log each user touch location on the keyboard for a plurality of modified first strings;
calculate a user adjustment vector from the plurality of logged user touch locations; and
modify the spatial vector with the user adjustment vector.

6. The computer readable storage medium of claim 1, wherein the keyboard is a touch screen keyboard.

7. The computer readable storage medium of claim 1, wherein the keyboard is an optical projection on a surface.

8. An apparatus comprising:
a computer readable storage medium storing a computer readable program;
a processor executing the computer readable program, the computer readable program comprising
a substitution cost module calculating a substitution cost between a first character of a first string and a second character of a second string;
a spatial vector module calculating a spatial vector between the first character and the second character from a location of a first key representing the first character on a keyboard and a location of a second key representing the second character on the keyboard and modifying the substitution cost if the spatial vector is less than a spatial threshold; and
an edit distance module calculating an edit distance between the first string and the second string using the modified substitution cost for the substitution cost of substituting the first character with the second character.

9. The apparatus of claim 8, wherein the modification of the substation cost c is calculated as k₁*c where k₁ is a constant.

10. The apparatus of claim 8, wherein the modification of the substation cost c is calculated as c*k₂*(v/vₘₐₓ)² where k₂ is a constant, v is a length of the spatial vector from the first key to the second key and vₘₐₓ is a longest spatial vector from the first key to any other key on the keyboard.

11. The apparatus of claim 8, wherein modification of the substation cost c is calculated as k₃*(1−a)*c where a is an area of a user touch location within an area of the second key divided by a total area of the user touch location and k₃ is a constant.

12. The apparatus of claim 8, the substitution cost module further modifying the first string to the second string in response to the edit distance and the computer readable program further comprising:
a touch location module logging each user touch location on the keyboard for a plurality of modified first strings and calculating a user adjustment vector from the plurality of logged user touch locations; and
a user adjustment module modifying the spatial vector with the user adjustment vector.

13. The apparatus of claim 8, wherein the keyboard is a touch screen keyboard.

14. The apparatus of claim 8, wherein the keyboard is an optical projection on a surface.

15. A method comprising:
calculating, by use of a processor, a substitution cost between a first character of a first string and a second character of a second string;
calculating, by use of a processor, a spatial vector between the first character and the second character from a location of a first key representing the first character on a keyboard and a location of a second key representing the second character on the keyboard;
modifying, by use of a processor, the substitution cost if the spatial vector is less than a spatial threshold; and
calculating, by use of a processor, an edit distance between the first string and the second string using the modified substitution cost for the substitution cost of substituting the first character with the second character.

16. The method of claim 15, wherein the modification of the substation cost c is calculated as k₁*c where k₁ is a constant.

17. The method of claim 16, wherein k₁ is in the range of 0.5 to 0.67.

18. The method of claim 15, wherein the modification of the substation cost c is calculated as c*k₂*(v/vₘₐₓ)² where k₂ is a constant, v is a length of the spatial vector from the first key to the second key and vₘₐₓ is a longest spatial vector from the first key to any other key on the keyboard.

19. The method of claim 15, wherein modification of the substation cost c is calculated as k₃*(1−a)*c where a is an area of a user touch location within an area of the second key divided by a total area of the user touch location and k₃ is a constant.

20. The method of claim 15, further comprising:
logging each user touch location on the keyboard for a plurality of modified first strings;
calculating a user adjustment vector from the plurality of logged user touch locations; and
modifying the spatial vector with the user adjustment vector.
